(19) United States
(12) Patent Application Publication
(10) Pub. No.: US 2016/0117231 A1
(43) Pub. Date: Apr. 28, 2016

(54) Complex Network Modeling For Disaster Recovery

(71) Applicant: UNITRENDS, INC., Columbia, SC (US)

(72) Inventors: Kevin Sin Yee Lee, North Point (HK); Jorke Samuel Odolphi, Balmain (AU); Hiroshi Wada, Parramatta (AU); Anna Liu, Lane Cove (AU); Vernon Keith Boland, Lexington, SC (US)

(73) Assignee: UNITRENDS, INC., Columbia, SC (US)

(21) Appl. No.: 14/521,686

(22) Filed: Oct. 23, 2014

(51) Int. Cl. G06F 11/20; G06F 11/14

(52) U.S. Cl. CPC G06F 11/2033; G06F 11/1469; G06F 2201/84

(57) ABSTRACT

A cloud based method and system for the backup and recovery of a computer or computer system is provided with the ability to determine a network model that emulates the network environment of the computer or computer system being backed up. Should a disaster event occur, the network model is used by a disaster recovery computer to construct a virtual network environment that emulates the network environment of the backed up computer or computer system.

### FIELD OF THE INVENTION

The present invention relates generally to disaster recovery for computer platforms and more specifically to aspects of using complex network modeling to convert the complex network infrastructure of failed computer platforms to an equivalent network infrastructure on computer platforms used to recover the failed computer platforms.

### BACKGROUND

It is common to implement some level of disaster recovery for a computer or computer system. A disaster recovery plan often includes one or more techniques for backing up part or all of the data, software, and information required to operate a computer or a computer system so that the functionality of the computer or computer system can be recovered in the event of a disaster or interruption to normal operations. Typically, the more critical the application executed by the computer, the higher the level of disaster recovery implemented by the computer.

Disaster recovery systems may suitably provide functionality to backup and restore individual servers both at the physical and virtual level and to provide the ability to recover the server in the event of a disaster that renders the server unusable or inaccessible. These backups are often referred to as bare-metal backups because a new server can be restored from a blank or “bare metal” state back to the state of the original server including its operating system and applications.

A disaster recovery solution for a computer server includes backing up the programs, data and infrastructure information required to recover the function of the computer server on another machine. The infrastructure information for the computer server includes a description of the network configuration attached to the computer server and the network routing and address information used by the computer server to communicate over the network. For a cloud based disaster recovery solution, the functions of the backed up computer server are recovered on a cloud based virtual machine. For the recovered computer server to function properly, the network infrastructure used on the backed up computer server must be converted to the network infrastructure of the cloud based virtual machine. The conversion of the network configuration is critical to performing a successful cloud based disaster recovery. When the network configuration is relatively simple, the conversion can be performed by a simple one to one mapping of resources. However when the network configuration is complex, simple mapping of resources does not work.

### SUMMARY

Among its several aspects, the present invention seeks to overcome or ameliorate at least one of the disadvantages of the prior art, or to provide a useful alternative.

Among its several aspects, the present invention recognizes that when a computer is recovered after a disaster event, the network environment of the backed up computer must be fully recreated. This full recreation means that all the inherent features and functions of the backed up computer's network environment must be recreated in the network environment of the recovery computer.

Among its several aspects, the present invention further recognizes that when the backed up computer has a complex network environment, a simple direct mapping of the elements from the backed up computer to the virtual network environment of the recovery computer is not possible because the elements of the two network environments are not the same. Instead, a model of the complex network environment of the backed up computer must be created using primitive network functions of the virtual network environment. Once the model is created, the virtual network environment of the recovery computer can be configured to emulate the backed up computer's complex network environment.

Among its several aspects, the present invention also recognizes that the disaster recovery system may suitably be a cloud based solution that uses the Internet as a communication path to the backed up computer. The cloud based solution is based on computers that support a virtual machine and virtual network environment that can be configured to emulate the environment of the backed up computer.

Among its several aspects, the present invention also recognizes that the disaster recovery system may suitably be a local solution that uses a local network to communicate with the backed up computer. The local network may include a virtual private network that is carried over the Internet. The local solution could be used for example with a server farm having hundreds or thousands of computer platforms. The local solution is based on recovery computers that support a virtual machine and virtual network environment that can be configured to emulate the environment of the backed up computer platforms.

In accordance with an embodiment of the present invention, there is provided a computer implemented method performed by a disaster recovery computer responsible for backing up a first server and recovering the first server in the event of a disaster to a recovery server. The method may suitably comprise: maintaining first server backup information for the first server wherein the first server has a complex network environment that is defined within the first server backup information; receiving a disaster event for the first server which initiates a recovery process for the first server; after receiving the disaster event, generating a network model of the first server's complex network environment from the first server backup information wherein the network model is constructed using virtual network primitives available on the recovery server wherein the generated network model provides the equivalent features and functions of the first server's complex network environment; and causing the virtual network environment of the recovery server to be configured to implement the generated network model.

In accordance with an embodiment of the present invention, there is provided a disaster recovery system for recovering a first computer in the event of a disaster wherein the first computer has a complex network environment. The method may suitably comprise: a second computer operable to implement multiple virtual machines and a virtual network and to implement the features and functions of the first computer; a disaster recovery computer operable to communicate with the first and second computers and operable to execute software where the software, when executed, causes the disaster recovery computer to operate to: receive first computer backup information from the first computer wherein the first computer has a complex network environment that is defined within the first computer backup information; receive a disaster event for the first computer which initiates a recovery process for the first computer; generate a network model of the first computer's complex network environment from the first computer backup information wherein the network model is constructed using virtual network primitives available on the second computer's virtual network wherein the generated network model provides the equivalent features and functions of the first computer's complex network environment; and cause the virtual network of the second computer to be configured to implement the generated network model.

In accordance with another embodiment of the present invention, there is provided one or more non-transitory digital storage media storing instructions which, when executed by one or more computing devices, causes performance of a method comprising: maintaining first server backup information for the first server wherein the first server has a complex network environment that is defined within the first server backup information; receiving a disaster event for the first server which initiates a recovery process for the first server; after receiving the disaster event, generating a network model of the first server's complex network environment from the first server backup information wherein the network model is constructed using virtual network primitives available on the recovery server wherein the generated network model provides the equivalent features and functions of the first server's complex network environment; and causing the virtual network environment of the recovery server to be configured to implement the generated network model.

A more complete understanding of the present invention, as well as further features and advantages of the invention, will be apparent from the following Detailed Description and the accompanying Drawings.

### BRIEF DESCRIPTION OF THE DRAWINGS

The present invention may take form in various components and arrangement of components and in various methods. The drawings are only for purposes of illustrating example embodiments and alternatives and are not to be construed as limiting the invention. The drawings are not necessarily drawn to scale. Throughout the drawings, like element numbers are used to describe the same parts throughout the various drawings, figures and charts.

FIG. 1 is a high level block diagram of illustrating a cloud based disaster recovery system in accordance with an embodiment of the present invention.

FIG. 2 is a high level block diagram illustrating a real physical server in accordance with an embodiment of the present invention.

FIG. 3A is a high level block diagram illustrating a first representation of the complex virtual network infrastructure for a server being backed up.

FIG. 3B is a high level block diagram illustrating a second representation of the complex virtual network infrastructure for a server being backed up.

FIG. 4 is a high level block diagram illustrating a generated model of the complex network environment depicted in FIGS. 3A and 3B.

FIG. 5 is a high level flowchart illustrating a method of generating a model of the complex network environment according to an embodiment of the present invention.

### DETAILED DESCRIPTION

In the following description, numerous details are set forth to provide an understanding of the claimed invention. However, it will be understood by those skilled in the art that aspects of the claimed invention may be practiced without utilizing all of these details and that numerous variations or modifications from the described embodiments are possible and envisioned.

A computer server may suitably be implemented as a real physical computer that executes an operating system and applications or as a virtual machine that executes an operating system and applications in a virtual environment. A virtual machine is an emulation of a particular computer architecture which means it provides the full functionality of the emulated architecture. A real physical computer server may support multiple different virtual machines at the same time.

Disaster recovery solutions can be implemented as local solutions or cloud based solutions. In local disaster recovery solutions, the computers and systems being backed up and disaster recovery solution may suitably be commonly owned and communicate with each other over a local or private network. The computers being backed up and the recovery computer may be local to each other or may be in separate locations. For example, the recovery computer may be in a different building on the same campus, or in a different location in another region of the country or the world. The computers and servers being backed up may perform a number of different functions and as such they may not all be configured identically. While the computer servers used to recover the backed up computers and servers may have the same hardware configuration, their virtual software and network environments can be configured to emulate the backed up computer or server.

In cloud based disaster recovery solutions, the disaster recovery systems are remotely located from the backed up computers and servers and they communicate with the backed up computers and servers over the Internet. Typically, it is not possible to provide physical hardware and network architectures that are identical to all the computers and systems that are being backed up. To provide as much flexibility as possible, the cloud based disaster recovery solutions use virtual machines and virtual network switches. The virtual machines can be quickly configured to emulate a real physical server that is being backed up or a virtual machine running an application that is being backed up. The virtual network switches can be configured using low level building block functions to emulate the network environment or infrastructure of the backed up computer or system.

For simple network configurations, configuring a virtual network switch to emulate a backed up computer can be accomplished by a simple one to one mapping of network elements of the backed up computer to elements of the virtual network switch. A simple network configuration may suitably have a single network interface card and one subnet. For complex networks, this is not possible because all of the network features of the backed up computer cannot be mapped directly to low level building block functions of the virtual network switch. A complex network configuration may suitably include multiple network interface cards and multiple subnets. For a complex network and in accordance with the present invention, a model is first generated that simulates the complex network environment or infrastructure of the backed up computer or system. The model is implemented using low level building block functions of the virtual network switch. In some cases, multiple elements of the backed up computer's complex network environment are implemented using a single low level function. In other cases, multiple low level functions are used to implement a single element of the backed up computer's complex network environment.

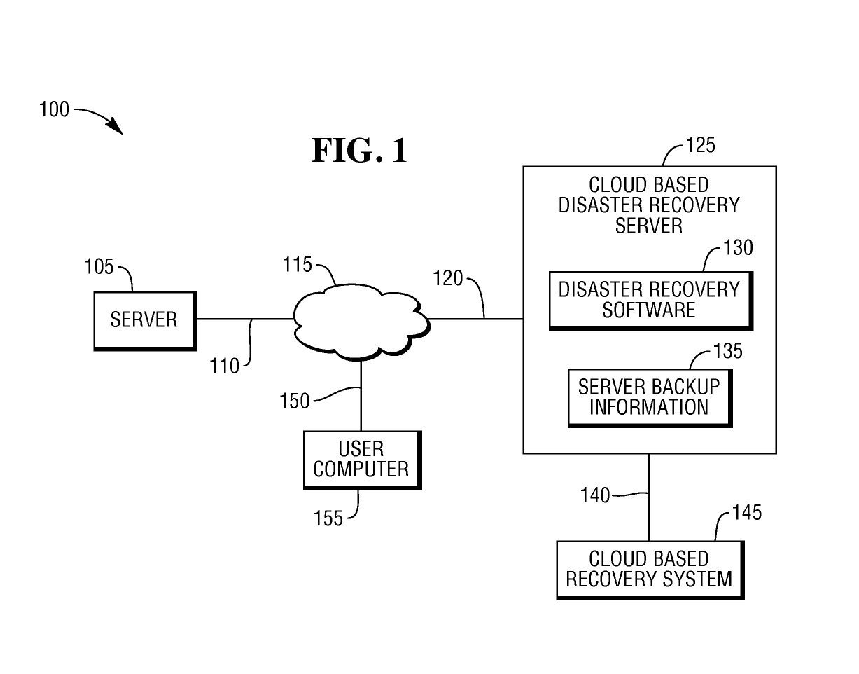

Turning now to FIG. 1, a high level block diagram of illustrating a cloud based disaster recovery system 100 in accordance with an embodiment of the present invention is shown. The system 100 includes a server 105 connected to the Internet 115 over a network 110. Computer solutions that communicate over the Internet 115 are in some cases marketed or referred to as cloud based solutions. The term cloud has come to be synonymous with the Internet 115 or communications over the Internet. The system 100 further includes a user computer 115 connected to the Internet 115 over a network 150. The user computer 155 communicates with the server 105 over the Internet 115 and the server 105 provides a function to the user computer 155. In different embodiments, the server 105 provides different functions to the user computer 155. For example, the server 105 may suitably implement a web server and provide web pages that are accessed by the user computer 155. In some embodiments, communication over the Internet 115 includes using a virtual private network (VPN) connection.

The system 100 further includes a cloud based disaster recovery server 125 connected to the Internet 115 over a network 120. The cloud based disaster recovery server 125 executes disaster recovery software 130 that receives and maintains server backup information 135 for computer servers such as server 105. The server backup information 135 includes all the information required to recover the server 105 should a disaster event occur. A cloud based recovery server 145 is connected to the cloud based disaster recovery server over a network 140. The recovery server 145 is used to recover servers that are backed up and experience a disaster event. In other embodiments, there are multiple cloud based recovery servers. The disaster recovery software 130 controls the operation of the cloud based recovery server 145.

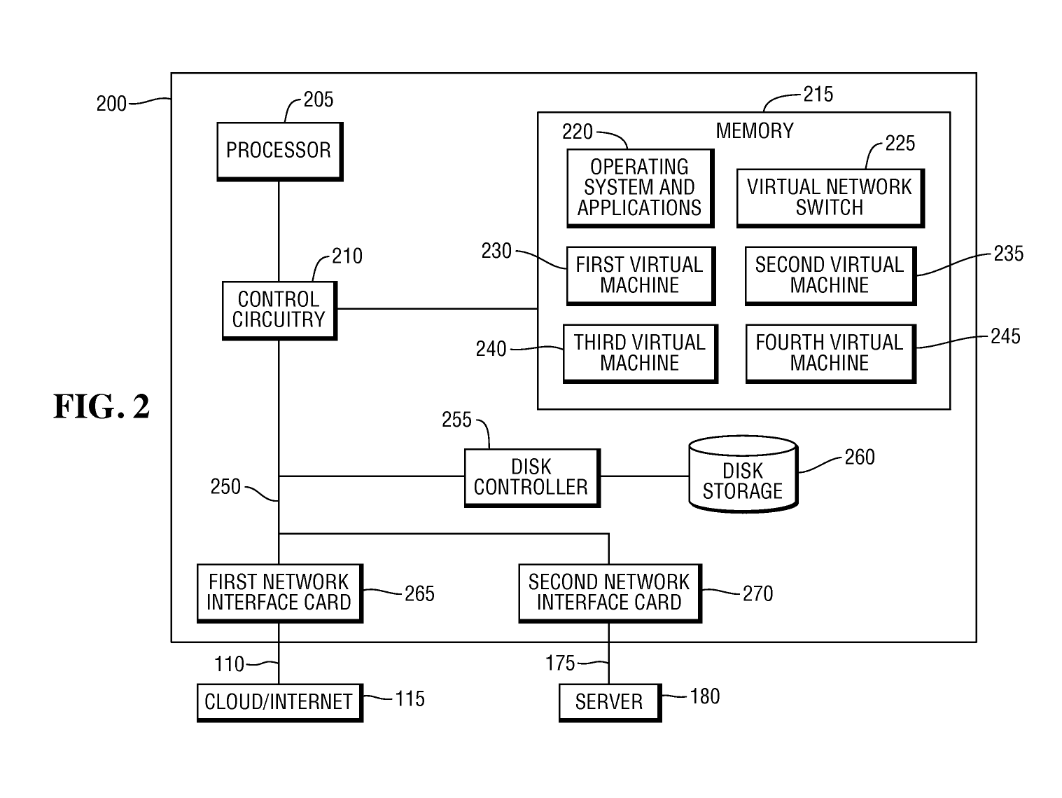

The server 105, the cloud based disaster recovery server 125 and the cloud based recovery server 145 may suitably be implemented using one or more different configurations of computer hardware and software. FIG. 2 provides an illustration of an embodiment of a real physical server 200 that may suitably be configured to implement each of the three servers 105 125 145. In other embodiments, one or more of the three servers 105 125 145 may suitably be implemented using a converged infrastructure platform as described in more detail in a provisional U.S. patent application titled “DISASTER RECOVERY OF CONVERGED INFRASTRUCTURE PLATFORMS”, Ser. No. 61/968,137, filed on Mar. 20, 2014 having the same assignee as this application and which is hereby incorporated by reference in its entirety into this application.

FIG. 2 provides a high level block diagram illustrating the real physical server 200 in accordance with an embodiment of the present invention. The real physical server 200 may suitably be used to directly execute applications that perform required functions or it may suitably execute software that creates one or more virtual machines (VMs) where the one or more virtual machines execute applications that perform the required functions.

The real physical server 200 includes a processor 205, control circuitry 210, a memory 215, a disk controller 255, a disk storage 260, a first network interface card 165 and a second network interface card 270. It will be recognized that some embodiments may suitably include only one network interface card or more than two network interface cards. Additionally in some embodiments, the processor 205 includes multiple processors or processors with multiple cores or a combination thereof.

The control circuitry 210 includes components that allow the processor 205 to communicate with: the memory 215 to read and write to the contents of the memory 215; the disk controller 255; and the first network interface card 265.

The memory 215 uses non-transitory storage devices including both volatile and non-volatile memory. The non-volatile memory may suitably include flash memory, other types of solid state electronic memory and rotating storage devices, such as disk drives or the like. Non-volatile memory retains stored information after power is removed from the memory and until power is restored. Computer instructions in the form of an operating system and applications 220 are stored in the memory 215. When the computer instructions are executed by the processor 205 they cause the processor 205 to control the devices, controllers and peripherals attached to or part of the server 205 and to perform the functions of the real physical server 200. The applications 220, when executed, may suitably provide features or functions directly or they may suitably implement a first, second, third and fourth virtual machine 230 235 240 245 respectively and a virtual network switch 225. When the virtual machines 230 235 240 245 are implemented, one or more of the applications 220 are executed by the one or more of the virtual machines 230 235 240 245 to provide features and functions. Other embodiments of the present invention will include either additional or fewer virtual machines.

In some embodiments, the virtual network switch 225 is implemented using an open source software application called Open vSwitch or sometimes a vendor proprietary vSwitch. Either type of vSwitch provides a switching network stack for hardware virtualization environments and supports multiple protocols and standards commonly used by computer networks. A vSwitch provides network automation and customization through the use of programmatic extensions. Other embodiments may suitably use different implementations of a virtual network switch.

The disk storage 260 includes one or more disk drives. In some embodiments, some or all of the disk drives are solid state disk drives where the rotating disks are replaced by solid state memory devices that have no moving mechanical components. The solid state memory devices provide increased performance over rotating disk drives.

The real physical server 200 may suitably include one or more network interface cards (NICs). In the illustrated embodiment, the real physical server 200 has the first network interface card 265 that communicates with the network 110 which communicates over the cloud 115 which in reality is the Internet. The second network interface card communicates over network 175 to a server 180. The server 180 can be a local server used to provide a server or function to the real physical server 200 but it is isolated from the network 110.

When multiple physical or logical NICs are used, the plural NICs allows the networks attached to each NIC to be isolated from the networks attached to the other NIC or NICs. This approach provides isolation and security for the different networks. For example, a first network connected to a first NIC may suitably connect to the Internet and as such is susceptible to hacking attacks from an Internet based computer. A second network connected to a second NIC may suitably be a private and secure network that connects to a second server that provides a valuable function. Using separate NICs allows the first network to be isolated from the second network which provides an extra level of security by preventing Internet based attacks from having direct access to the second server. When server 105 is recovered after a disaster event, this extra level of isolation and security provided by multiple NICs must be maintained along with other network configurations and information. This extra level of isolation and security is sometimes referred to as an inherent feature because the extra level of isolation and security are automatically present in the configuration.

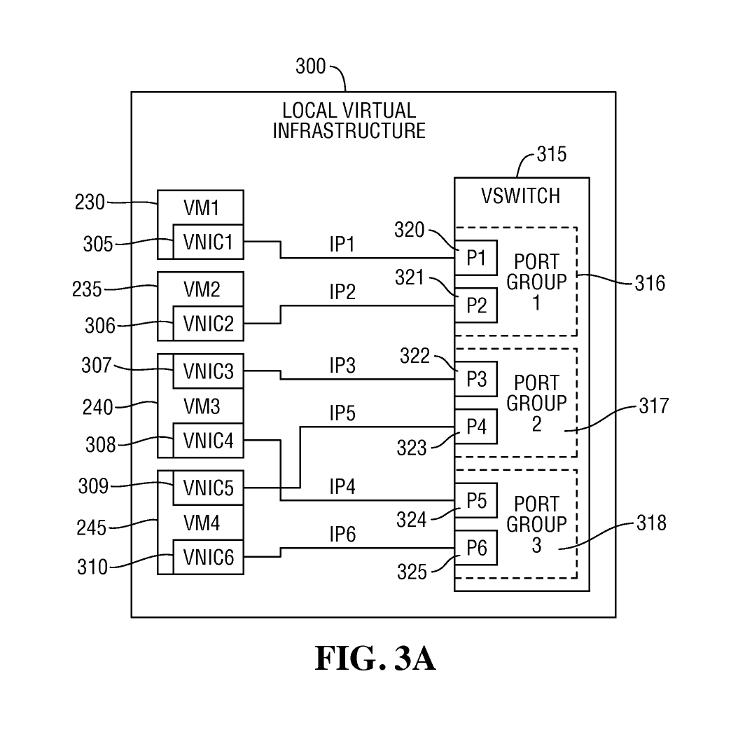

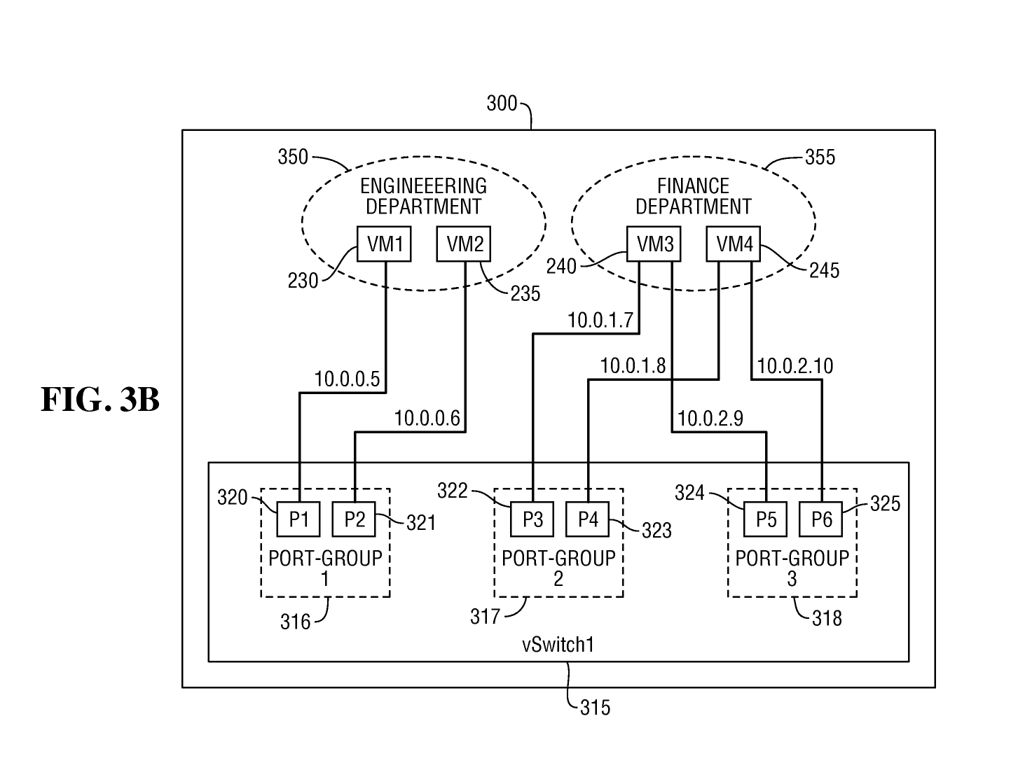

With reference to FIG. 3A, a high level block diagram is shown that illustrates one representation of a complex virtual network infrastructure for the server 105 being backed up. The server 105 supports four virtual machines. These are VM1 230, VM2 235, VM3 240 and VM4 245. VM1 230 supports a single virtual network interface card (VNIC1) 305. VM2 235 supports a single virtual network interface card (VNIC2) 306. VM3 supports two virtual network interface cards (VNIC3, VNIC4) 307 308. VM4 also supports two virtual network interface cards (VNIC5, VNIC6) 309 310.

The server 105 also supports a virtual network switch (VSWITCH) 315. The VSWITCH 315 is configured to have three port groups: port group one (PG1) 316, port group two (PG2) 317, and port group three (PG3) 318. PG1 316 has two port connections: port one (P1) 320 and port two (P2) 321. PG2 317 has two port connections: port three (P3) 322 and port four (P4) 323. PG3 318 has two port connections: port five (P5) 324 and port six (P6) 325. An Internet protocol address is referred to as an IP address. IP address IP1 is used to communicate between VNIC1 305 and P1 320. IP address IP2 is used to communicate between VNIC2 306 and P2 321. IP address IP3 is used to communicate between VNIC3 307 and P3 322. IP address IP4 is used to communicate between VNIC4 308 and P4 323. IP address IP5 is used to communicate between VNIC5 309 and P5 324. IP address lP6 is used to communicate between VNIC6 310 and P6 325.

With reference to FIG. 3B, a high level block diagram is provided that illustrates a second representation of the complex virtual network infrastructure for the server 105 being backed up. The representation of FIG. 3B has a number of features in common with the representation of FIG. 3A. In FIG. 3B, VM1 230 and VM2 235 are grouped together in a first network isolation group 350 that performs functions used by an engineering department. VM3 240 and VM4 245 are grouped together in a second network isolation group 355 that performs functions used by a finance department. The isolation groups are used to separate the functions used by the two departments for security reasons. FIG. 3B also has assigned actual IP addresses to the connections between ports and virtual machines. In this embodiment, the IP addresses are assigned as follows. IP1 is assigned IP address 10.0.0.5. IP2 is assigned IP address 10.0.0.6. IP3 is assigned IP address 10.0.1.7. IP4 is assigned IP address 10.0.1.8. IP5 is assigned IP address 10.0.2.9 and IP6 is assigned IP address 10.0.2.10.

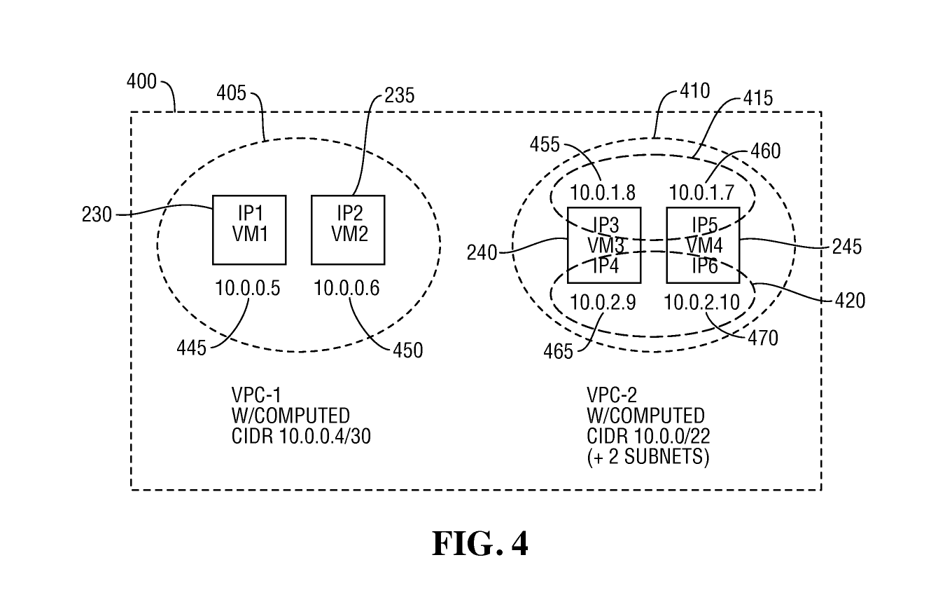

Turning now to FIG. 4, a high level diagram is provided illustrating a generated model 400 of the complex network environment depicted in FIGS. 3A and 3B. The model is constructed using primitive functions of a virtual network supported on the recovery server 145. One such function is a virtual private cloud (VPC). A VPC is an on demand configurable pool of shared network resources that provides a level of isolation from other VPCs. The VPC is defined to have a classless inter-domain routing (CIDR) range and one or more subnets.

A first virtual private cloud (VPC1) 405 is created that includes VM1 230 and VM2 235 and a single subnet that includes IP addresses 10.0.0.5 and 10.0.0.6. VPC1 405 has a CIDR range of 10.0.0.4/30. A second virtual private cloud (VPC2) 410 is created that includes VM3 240 and VM4 245. Within VPC2 410, there is a first subnet 415 and a second subnet 420. The first subnet 415 has a CIDR range of 10.0.1/24 and the second subnet 420 has a CIDR range of 10.0.2/24. In addition, the VPC2 410 has a CIDR range of 10.0.0/22.

There is an inherent level of network isolation between VPC1 405 and VPC2 410. There is also an inherent level of network isolation between VPC3 415 and VPC4 420.

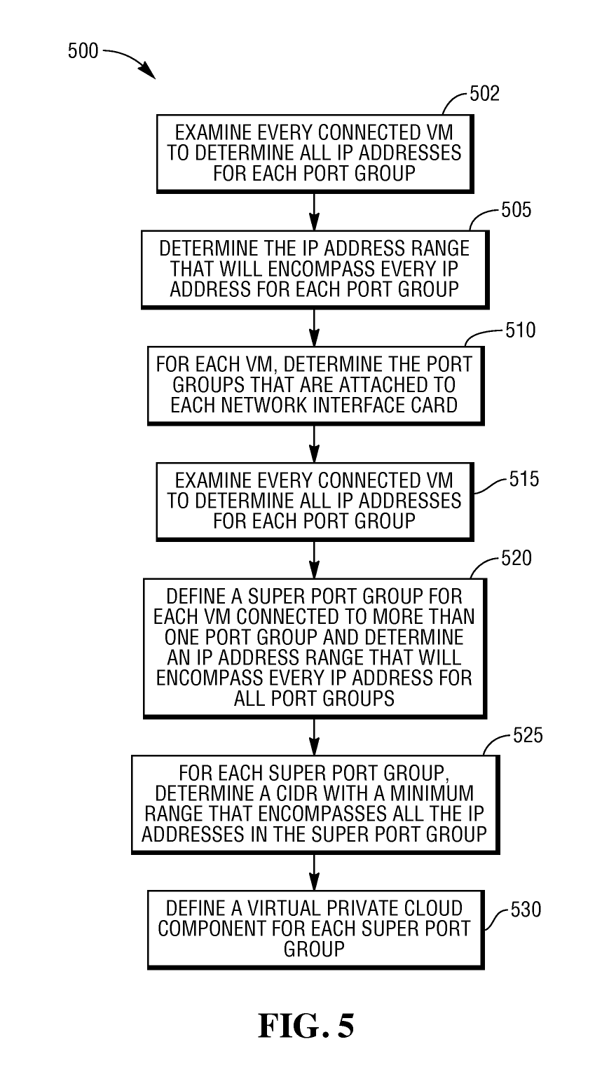

FIG. 5 provides a high level flowchart illustrating a method 500 of generating a complex network model according to an embodiment of the present invention. When a disaster event for the server 105 is received by the disaster recovery server 125, the disaster recovery server 125 must recover or recreate the last known state of the server 105 on the recovery server 145. This recreation includes recreating the complex network environment of the server 105. The last known state of the applications and data of the server 105 is stored in the server backup information 135. However, this information cannot be directly loaded on the recovery server 145 and executed. The complex network environment of the server 105 is stored within the server backup information 135 but cannot be mapped directly onto the recovery server 145 because the elements of the network environments to not match. The complex network environment must first be modeled using primitive functions of the recovery server's 145 virtual network. Once the model is constructed, the virtual network of the recovery server 145 can be configured to emulate the complex network environment of the server 105. The method below is an example of generating a complex network model for the above embodiment.

At step 502, every virtual machine in the complex network environment of the server 105 is examined to determine the IP addresses used to communicate with each port group. This information is stored in the server backup information 135. There are three port groups (PG1, PG2, PG3) 316 317 318. The following IP list is generated:

List all IPs in Each Port Group

Port Group 1: 10.0.0.5, 10.0.0.6

Port Group 2: 10.0.1.7, 10.0.1.8

Port Group 3: 10.0.2.9, 10.0.2.10

At step 505, determine the IP address range that will encompass every IP address for each port group. The IP address range is expressed as a CIDR range. The determined CIDR range for each port group is:

Subnet Range for Each Port Group

Port Group 1: 10.0.0/24

Port Group 2: 10.0.1/24

Port Group 3: 10.0.2/24

At step 510, for each virtual machine, determine the port groups that are attached to each network interface in a virtual machine. The determined port groups for each virtual machine are:

List of Port Groups for Each Virtual Machine (VM)

VM1: Port Group 1

VM2: Port Group 1

VM3: Port Group 2, Port Group 3

VM4: Port Group 2, Port Group 3

At step 515, examine every connected virtual machine to determine all IP addresses for each port group. The determined IP addresses are:

Determined IP Addressed for Each Virtual Machine

VM1: 10.0.0.5 (Port Group 1)

VM2: 10.0.0.6 (Port Group 1)

VM3: 10.0.1.7 (Port Group 2), 10.0.2.9 (Port Group 3)

VM4: 10.0.1.8 (Port Group 2), 10.0.2.10 (Port Group 3)

At step 520, define a super port group for each virtual machine connected to more than one port group or for multiple virtual machines connected to the same port group and determine an IP address range that will encompass every IP address for each super port group. When a virtual machine communicates with more than one port group, a super port group must be created. The super port group will also have subnets that must be defined. In this embodiment, two super port groups are created. Virtual machine one 230 and virtual machine two 235 are connected to port group one 316 so virtual machine one 230 and virtual machine two 235 are combined into super port group 1. Super port group 2 is created as shown below.

Super Port Group Definitions:

Super Port Group 1: Port Group 1—subnet: 10.0.0.5 (min),10.0.0.6 (max)

Super Port Group 2: Port Group 2—subnet: 10.0.1.7 (min), 10.0.1.8 (max)
Port Group 3—subnet: 10.0.2.9 (min), 10.0.2.10 (max)

At step 525, for each super port group, determine a CIDR range that encompasses all the IP addresses in the super port group. The determined CIDRs are:

CIDRs for Each Super Port Groups:

Super Port Group 1: 10.0.0.4/30

Super Port Group 2: 10.0.0/22

At step 530, a virtual private cloud (VPC) component is defined for each super port group. When a super port group has only one subnet, the IP range for the subnet becomes the IP range for the entire super port group and no subnets are needed or defined. When a super port group has two or more subnets, the IP range for each of the subnets are summed together to form the IP range for the super port group and each subnet is retained. The defined VPCs are listed below:

VPCs for Each SPG

VPC1: 10.0.0.4/30, includes VM1 & VM2

VPC2: 10.0.0/22, includes VM3 & VM4
subnet1: 10.0.1/24
subnet2: 10.0.2/24

The virtual network of the recovery server 145 is then configured to have two VPCs that have the same configuration as VPC1 405 and VPC2 410. After the virtual network environment has been recovered, a command to start execution of the recovery server 145 is transmitted to the recovery server 145.

Although the present invention has been described with particular reference to certain preferred embodiments thereof, variations and modifications of the present invention can be effected within the spirit and scope of the following claims.

What is claimed is:

1. A computer implemented method performed by a disaster recovery computer responsible for backing up a first server and recovering the first server in the event of a disaster to a recovery server, the method comprising:
maintaining first server backup information for the first server wherein the first server has a complex network environment that is defined within the first server backup information;
receiving a disaster event for the first server which initiates a recovery process for the first server;
after receiving the disaster event, generating a network model of the first server's complex network environment from the first server backup information wherein the network model is constructed using virtual network primitives available on the recovery server wherein the generated network model provides the equivalent features and functions of the first server's complex network environment; and
causing the virtual network environment of the recovery server to be configured to implement the generated network model.

2. The method of claim 1, wherein the disaster recovery computer communicates with the first server over the Internet.

3. The method of claim 1, wherein the first server supports multiple virtual machines each with different virtual network connections to one or more port groups.

4. The method of claim 3, wherein generating the network model includes determining all IP addresses for each port group for each virtual machine.

5. The method of claim 4, wherein generating the network model includes for each port group determining an IP address range that encompasses every IP address for the port group.

6. The method of claim 5, wherein generating the network model includes for each virtual machine determining which port groups are attached.

7. The method of claim 6, wherein generating the network model includes for each virtual machine connected to multiple port groups creating a super port group that includes each of the connected port groups and determining an IP address range that encompasses every IP address of all the connected port groups.

8. The method of claim 7, wherein generating the network model includes for each of the super port groups determining the minimal CIDR that encompasses the determined IP address range for the super port group.

9. The method of claim 8, wherein generating the network model includes creating a virtual private cloud for each super port group wherein each virtual private cloud is defined to have one subnet for each port group wherein each subnet and the virtual private cloud has a defined minimal CIDR.

10. The method of claim 1, further comprising:
causing the virtual machines of the recovery server to be configured to execute the features and functions of the first server using the first server backup information; and
transmitting a command to the recovery server to start execution after the virtual network environment of the recovery server has been configured to model the first server and after the execution environment of the recovery server has been configured to execute the features and functions of the first server.

11. The method of claim 1, wherein the disaster recovery computer and recovery server are cloud based and remotely located from the backed up server.

12. The method of claim 1, wherein the first server backup information is received from the first server and includes the software, data and information required to recover the features and functions provided by the first server on the recovery server.

13. A disaster recovery system for recovering a first computer in the event of a disaster wherein the first computer has a complex network environment, the system comprising:
a second computer operable to implement multiple virtual machines and a virtual network and to implement the features and functions of the first computer;
a disaster recovery computer operable to communicate with the first and second computers and operable to execute software where the software, when executed, causes the disaster recovery computer to:
receive first computer backup information from the first computer wherein the first computer has a complex network environment that is defined within the first computer backup information;
receive a disaster event for the first computer which initiates a recovery process for the first computer;
generate a network model of the first computer's complex network environment from the first computer backup information wherein the network model is constructed using virtual network primitives available on the second computer's virtual network wherein the generated network model provides the equivalent features and functions of the first computer's complex network environment; and
cause the virtual network of the second computer to be configured to implement the generated network model.

14. The system of claim 13, where the software further causes the disaster recovery computer to:
store the received first computer backup information;
receive updated first computer backup information; and
update the first computer backup information using the received updated first computer backup information.

15. The system of claim 13, where the disaster recovery computer is cloud based and communicates with the first computer over the Internet.

16. The system of claim 14, where the first computer supports multiple virtual machines each with different virtual network connections to one or more port groups and where generating the network model includes determining all IP addresses for each port group for each virtual machine and for each virtual machine determining which port groups are attached.

17. The system of claim 16, where generating the network model includes for each port group determining an IP address range that encompasses every IP address for the port group.

18. The system of claim 17, where generating the network model includes for each virtual machine connected to multiple port groups creating a super port group that includes each of the connected port groups and determining an IP address range that encompasses every IP address of all the connected port groups.

19. The system of claim 18, where generating the network model includes for each of the super port groups determining the minimal CIDR that encompasses the determined IP address range for the super port group.

20. The system of claim 19, where generating the network model includes creating a virtual private cloud for each super port group wherein each virtual private cloud is defined to have one subnet for each port group wherein each subnet and the virtual private cloud has a defined minimal CIDR.

21. One or more non-transitory digital storage media storing instructions which, when executed by one or more computing devices, causes performance of a method comprising:
maintaining first server backup information for the first server wherein the first server has a complex network environment that is defined within the first server backup information;
receiving a disaster event for the first server which initiates a recovery process for the first server;
after receiving the disaster event, generating a network model of the first server's complex network environment from the first server backup information wherein the network model is constructed using virtual network primitives available on the recovery server wherein the generated network model provides the equivalent features and functions of the first server's complex network environment; and
causing the virtual network environment of the recovery server to be configured to implement the generated network model.
